(19) United States
(12) Patent Application Publication
(10) Pub. No.: US 2014/0033123 A1
(43) Pub. Date: Jan. 30, 2014

(54) USER INTERFACE AND METHOD FOR COMPARING A LOCAL VERSION OF A PROFILE TO AN ONLINE UPDATE

(71) Applicant: Gottfried Hockmann, Hamburg (DE)

(72) Inventor: Gottfried Hockmann, Hamburg (DE)

(73) Assignee: ADOBE SYSTEMS, INC., SAN JOSE, CA (US)

(21) Appl. No.: 12/512,482

(22) Filed: Jul. 30, 2009

(51) Int. Cl. G06F 3/048

(52) U.S. Cl. 715/810

(57) ABSTRACT

Systems and methods (“utility”) for comparing two or more product profiles are described herein. The utility may include a graphical user interface that is operative to compare and display the differences between product profiles so that a user may quickly determine whether to choose one of the profiles. The product profiles that are compared may include profiles representing two different products, or profiles representing different versions of the same product. Further, the product profiles being compared may include a first product profile stored locally on a user's computer and a second (update) product profile stored on a remote computer.

### BACKGROUND

1. Field

The present disclosure relates, in general, to software operated on computer systems, and, more particularly, to improved systems and methods for updating and comparing software product profiles on computer systems.

2. Relevant Background

Although computer program components are frequently upgraded and improved, ensuring that users have access to updates can be difficult. Currently, when new or updated library or content files are available, the information may be posted to web sites or sent to users on a compact disk (CD) or other traditional media.

When an update is available over the Internet, users may be required to access the relevant web site (i.e., site on the World Wide Web), choose to download an installer application and then run the installer application. Users typically allow the installer to determine whether or not any new material is applicable to the users' machine. When an update is available on traditional media such as a CD, the same process is required, except there is no downloading step. Users may be required to know when an update is available and how to obtain the update. Further, once users become aware that an update is available, they may be unsure of whether or not they need the proffered update and may go through the time consuming process of running the installer program without any need to do so.

Computer networks such as the Internet allow users to share resources such as files and hardware. The expansion of the Internet and the adoption of standards for the World Wide Web have made the viewing and downloading of files by a user almost effortless. The user need not know any programming languages. By simply running a Web browser, the user only needs to point and click to view and download desired files. The availability of such programs allows for easy collaboration and file sharing among like-minded individuals separated by great distances over a distributed computer network, which can literally span the entire globe.

In a conventional client/server infrastructure, a distributed computer network is set up to have at least one server node and multiple client nodes. In particular, each user node is a client that can access a server node over the network and, with the proper authorization, publish files to the server node. Once a file is published to the server node, other clients on the network can access the server node to view or downloads the file. Additionally, the server node can allow a client to automatically send a file to another client that is reachable over the network. The client simply sends the file to the server node along with information identifying the desired recipient, and the server node sends the file on to the corresponding client.

It is now common practice for computer applications to include an “update” feature which checks a location on the Internet for updates to its source code. A computer application typically checks for an update whenever it launches, periodically or in response to a user request. The update operation downloads the updated program components and installs them on the user's computer system.

### SUMMARY

The following embodiments and aspects thereof are described and illustrated in conjunction with systems, tools, and methods which are meant to be exemplary and illustrative, and not limiting in scope. In various embodiments, one or more of the above-described problems may have been reduced or eliminated, while other embodiments are directed to other improvements or features.

Improved systems and methods for comparing two or more product profiles are described herein. The systems and methods may include a computer system that includes a graphical user interface that is operative to compare and display the differences between product profiles so that a user may quickly determine whether to choose one of the profiles. The product profiles that are compared may include profiles representing two (or more) different products (e.g., mobile devices or other products), or profiles representing different versions of the same product. Further, the product profiles being compared may include a first product profile stored locally on a user's computer and a second (update) product profile stored on a remote computer.

According to a first aspect, a computer-implemented method performed on a first computer is provided. The method includes first retrieving a list of attributes associated with a first product profile stored on the first computer, the first product profile being representative of a product. The method also includes second retrieving a list of attributes associated with a second product profile stored on a second computer communicatively coupled with the first computer, the second product profile being representative of a product. Additionally, the method includes processing the attributes associated with the first product profile and the attributes associated with the second product profile. For example, the processing may include comparing the attributes associated with the first product profile with the attributes associated with the second product profile. Further, the method includes displaying at least a subset of the attributes associated with the first product profile and the second product profile on a display of the first computer dependent upon the processing step. For example, the displaying step may include only showing the differences or highlighting the differences between the attributes of the first and second product profiles.

According to a second aspect, a computer-readable medium for comparing a first product profile with a second product profile is provided. The computer-readable medium includes computer-readable program code devices configured to cause a first computer to first retrieve a list of attributes associated with the first product profile stored on the first computer, the first product profile being representative of a product. The computer-readable medium also includes computer-readable program code devices configured to cause the first computer to second retrieve a list of attributes associated with a second product profile stored on a second computer communicatively coupled with the first computer, the second product profile being representative of a product. Additionally, the computer-readable medium includes computer-readable program code devices configured to cause the first computer to process the attributes associated with the first product profile and the attributes associated with the second product profile, wherein the processing includes comparing the attributes associated with the first product profile with the attributes associated with the second product profile. Further, the computer-readable medium includes computer-readable program code devices configured to cause the first computer to display at least a subset of the attributes associated with the first product profile and the second product profile on a display of the first computer, wherein the attributes included in the subset of the attributes include attributes that are different between the first product profile and the second product profile.

According to a third aspect, a computer system that includes a processor, a display, and a data storage device is provided. The computer system also includes a comparison module stored on the data storage device and executable by the processor. The comparison module includes computer-readable program code devices configured to cause the computer system to first retrieve a list of attributes associated with a first product profile stored on the computer system, the first product profile being representative of a product. The comparison module also includes computer-readable program code devices configured to cause the computer system to second retrieve a list of attributes associated with a second product profile stored on a remote computer system communicatively coupled with the computer system, the second product profile being representative of a product. Additionally, the comparison module includes computer-readable program code devices configured to cause the computer system to process the attributes associated with the first product profile and the attributes associated with the second product profile, wherein the processing includes comparing the attributes associated with the first product profile with the attributes associated with the second product profile. Further, the comparison module includes computer-readable program code devices configured to cause the computer system to display the attributes associated with the first product profile and the second product profile that are different from each other on the display.

In addition to the exemplary aspects and embodiments described above, further aspects and embodiments will become apparent by reference to the drawings and by study of the following descriptions.

### BRIEF DESCRIPTION OF THE DRAWINGS

FIG. 1 illustrates a block diagram of an exemplary computer system that includes an application program for comparing two or more product profiles.

FIG. 2 illustrates a block diagram of application programs that may be included in the computer system shown in FIG. 1.

FIGS. 3-6 illustrate various screenshots of a graphical user interface operative to compare two versions of device profiles for mobile phones.

FIG. 7 illustrates a process for comparing and displaying two versions of a device profile to a user of a computer system.

FIG. 8 illustrates a process for providing an update to a user utilizing a graphical user interface of a computer system.

### DETAILED DESCRIPTION

While this disclosure is susceptible to various modifications and alternative forms, specific embodiments thereof have been shown by way of example in the drawings and are herein described in detail. It should be understood, however, that it is not intended to limit the disclosure to the particular form disclosed, but rather, the disclosure is to cover all modifications, equivalents, and alternatives falling within the scope and spirit of the disclosure.

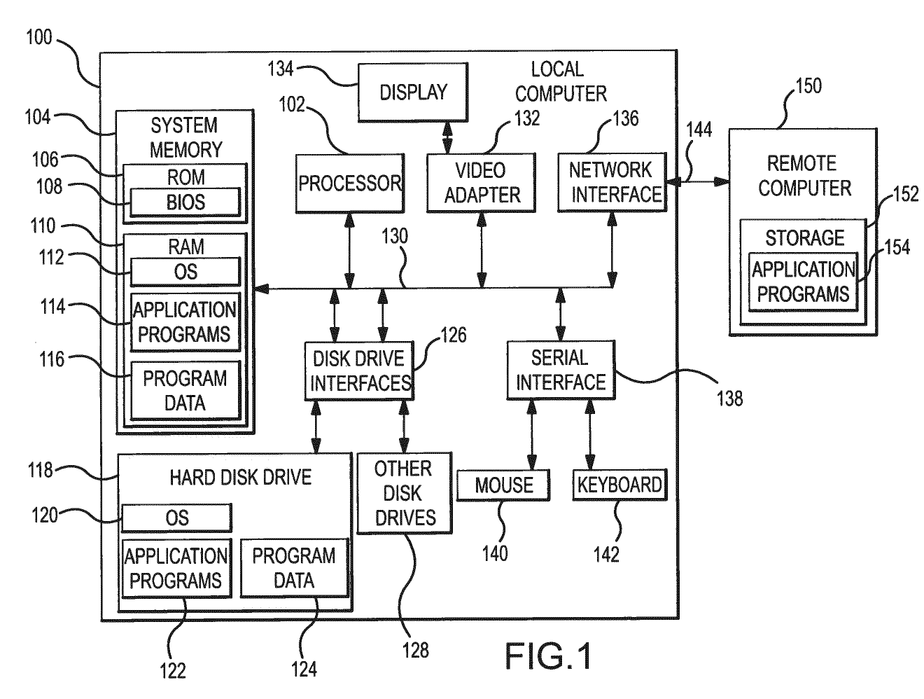

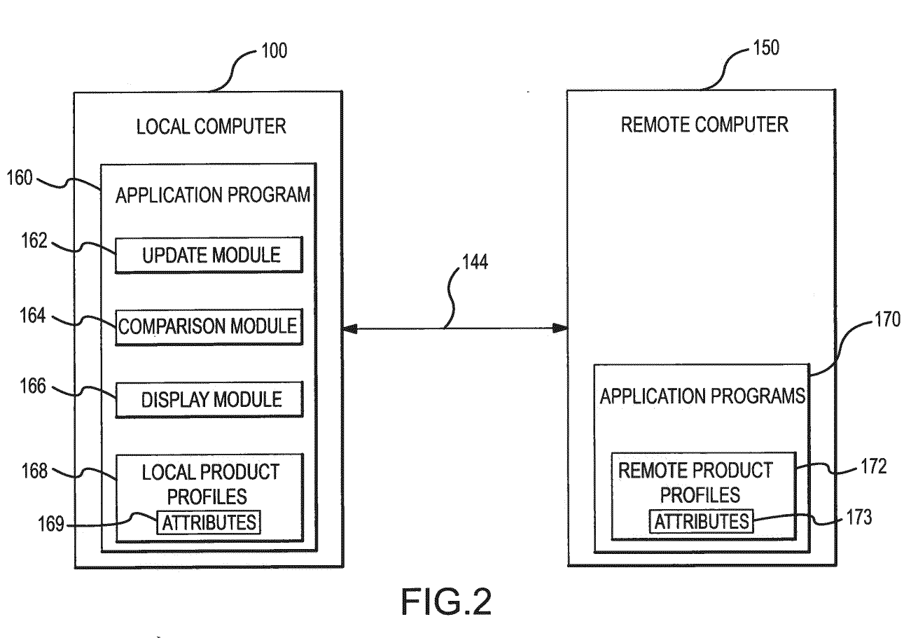

In the following discussion, systems and methods for comparing two or more product profiles are explored. For example, the product profiles may each include various attributes of a product, such as a mobile phone, computer, or other product. The comparison functions described herein may allow a user of a computer system to easily identify differences between two or more products or product profiles. Advantageously, the comparison functions may enable the user to decide whether to obtain (e.g., to download) a new (or updated) product profile based on the outcome of the comparison and a display of the differences between a new product profile and a previously obtained product profile. First, with reference to FIG. 1, an overview is provided of one type of computer system in which the comparison functionality may be implemented. Next, with reference to FIGS. 2-8, particular embodiments of systems and methods for providing comparisons between product profiles are discussed.

A block diagram illustrating one embodiment of a computer system 100 is shown in FIG. 1. In the illustrated embodiment, the computer system 100 includes a processor 102, system memory 104, and a system bus 130 that communicatively couples various system components including the system memory 104 to the processor 102. The system bus 130 may be any type of bus structure including a memory bus or memory controller, a peripheral bus, a local bus, or any other bus using any suitable bus architecture. The system memory 104 may include read-only memory (ROM) 106 and random access memory (RAM) 110. A basic input/output (BIOS) 108 may be stored in the ROM 106 and may include the basic routines that help to transfer information between elements within computer system 100, such as during startup. An operating system (OS) 112, application programs 114, and program data 116 may be stored in RAM 110.

The computer system 100 may also include a hard disk drive 118 and other disk drives 128 for storing data. The other disk drives 128 may include removable or permanent magnetic and/or optical disks. For example, the other disk drives 128 may include a CD-ROM drive or a DVD-ROM drive. The hard disk drive 118 and other disk drives 128 may be connected to the system bus 130 by one or more disk drive interfaces 126. In operation, the drives 118, 128 and their associated computer-readable media may provide nonvolatile storage of computer-readable instructions, data structures, program modules, and other data for the computer system 100. Although the exemplary embodiment described herein employs a hard disk drive 118, it will be appreciated by those skilled in the art that other types of computer-readable media operative to store data that is accessible by computer may also be used.

Various program modules may be stored on the hard disk drive 118, including an operating system 120, one or more application programs 122, other program modules, and program data 124. A user of the computer system 100 may enter commands and information into the computer system 100 using input devices such as a keyboard 142 and a mouse 140. Other input devices (not shown) may include a microphone, joystick, a scanner, or the like. These and other input devices may be coupled to the processor 102 through a serial port interface 138 that is coupled to the system bus 130. It should be appreciated that these input devices may be connected by other interfaces, such as a parallel port, game port, or a universal serial bus (USB). A display 134 (e.g., a monitor) may also be connected to the system bus 130 by an interface, such as a video adapter interface 132. In addition to the display 134, the computer system 100 may also include other peripheral output devices (not shown), such as speakers, printers, and the like.

The computer system 100 may operate in a networked environment using connections to one or more remote computers, such as a remote computer system 150. The remote computer 150 may be a personal computer, a server, a router, a network PC, and may include many or all of the elements described above relative to the computer system 100, although only a storage device 152 is illustrated in FIG. 1. The computer system 100 may include a network interface or adapter 136 to communicate with the remote computer 150 over the communications path 144 (e.g., the Internet). The network interface 136 may, for example, include a modem or other means for establishing communications with the remote computer 150 via the communications path 144. As can be appreciated, in a networked environment, program modules depicted in FIG. 1 to be stored on the computer system 100 may be stored in the remote memory storage device 152. Further, it is noted that the network connections shown in FIG. 1 are exemplary and other means of establishing a communications link between the computer system 100 and the remote computer 150 may be used.

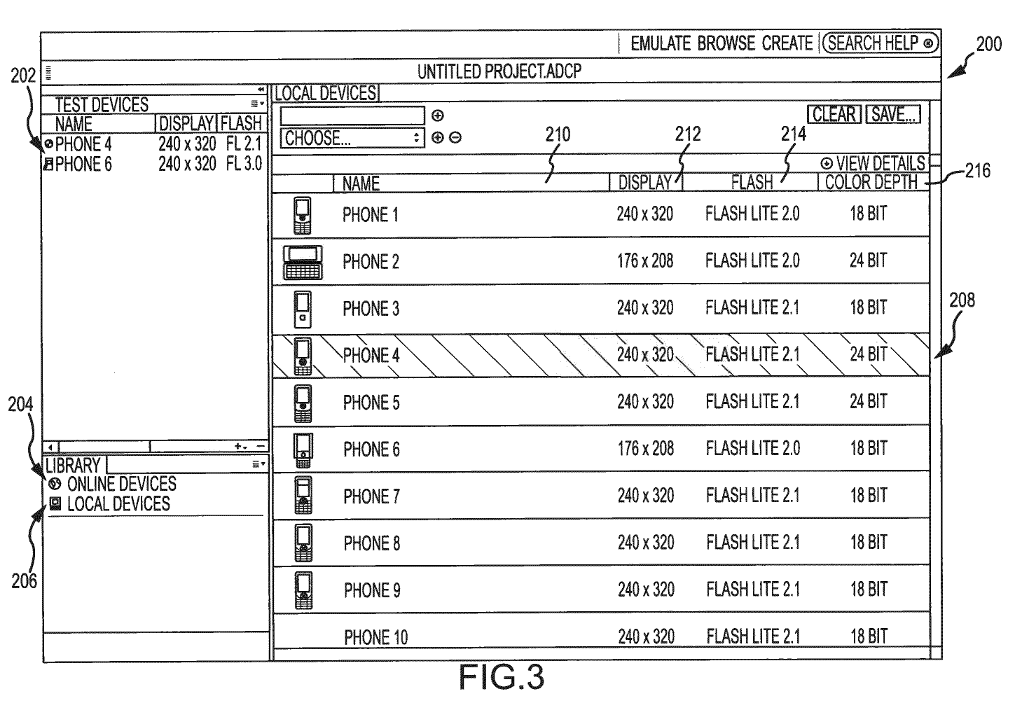

Referring now to FIG. 2, another block diagram of the computer system 100 and the remote computer 150 is shown. In this illustration, an application program 160 (e.g., the application program 160 may be one of the application programs 122 shown in FIG. 1) is run on the computer system 100, and an application program 170 (e.g., one of the application programs 154 shown in FIG. 1) is run on the remote computer 150. As an example, the application program 160 may be a program that allows users of the computer system 100 to work with various product profiles. The, product profiles may be a software representation of a physical product, such as a mobile phone, audio/video player, or other device. FIGS. 3-6 illustrate an embodiment wherein the application program 160 includes functionality for emulating a plurality of mobile phone devices using device profiles.

The application program 160 may include a plurality of local product profiles 168 each including a plurality of attributes 169 stored on the computer system 100 (e.g., stored on the hard disk drive 118 and/or RAM 110). As noted above, the local product profiles 168 may be software representations of physical products, and may include attributes 169 regarding the products including hardware information, software information, communications capabilities, and other attributes.

The application program 160 may also include an update module 162. The update module 162 may be operative to communicate with the remote computer 150 via the communications path 144 to determine whether new (or updated) product profiles are available from the remote computer 150. The remote computer 150 may include a plurality of remote product profiles 172 each including a plurality of attributes 173 stored in the storage device 152 and associated with the application program 170. In operation, the update module 162 of the computer system 100 may request product profile information from the application program 170 of the remote computer 150. In turn, the application program 170 may provide the update module 162 with a list of new or updated product profiles that are available for download to the computer system 100.

The update module 162 may receive from the remote computer 150 a list of attributes 173 for a new product profile. In turn, a comparison module 164 may process the list of attributes 173 into a form that is usable by a user of the computer system 100. For example, the comparison module 164 may receive the list of attributes 173 for the new product profile, and perform a comparison with the list of attributes 169 of a product profile already stored locally to determine which attributes are different between the two product profiles. In one embodiment, a comparison may be made between product profiles that represent different versions (e.g., updated software) of the same product. In other embodiments, a comparison may be made between product profiles that represent two separate products (e.g., two different models of mobile phones).

The application program 160 may also include a display module 166 that is operative to display the output from the comparison module 164 on a display, such as the display 134 shown in FIG. 1. The display module 166 may display lists of attributes for the local product profile and the remote product profile in a manner configured to provide a user of the computer system 100 the ability to easily determine any differences between the local product profile and the remote product profile. For example, the display module 166 may only display the differences between the two product profiles. This feature may be advantageous, for example, when there are a large number of attributes (e.g., 20 attributes, 50 attributes, 100 attributes, or the like), and relatively few differences between the two product profiles. In this case, it may be difficult for a user of the computer system 100 to easily determine the differences between a local product profile and a new product profile stored on the remote computer 150 if all the attributes for each product are displayed. By showing only the differences, users can quickly determine whether they would like to download the new or updated product profile from the remote computer 150. In this regard, users may quickly determine exactly how the updated profile would impact applications that have been developed for the existing product profile. For example, if a new product profile includes a different version of a media player than the existing product profile, a user may readily determine the impact for applications that use the media player of the product for which the updated product profile is available.

There are various reasons why a user may or may not want to download a new product profile. For example, in the case where the new product profile represents an updated version of a product profile already stored locally on the computer system 100, the user may not wish to incur an expense associated with the new product profile. Another reason may be that the differences between the local product profile and the new product profile are insignificant, so a user may simply decide that it is not important to download the newest product profile, or that downloading the newest product profile may adversely affect development that was performed using an existing product profile. Of course, there may be other factors that weigh in users' decisions as to whether or not to download new product profiles from the remote computer 150 to the local computer system 100.

It should be appreciated that the display module 166 may provide the attribute data for product profiles being compared in a variety of ways. For example, the display module 166 may show a subset or all of the available attributes for each of the product profiles, highlighting the differences between them. Highlighting may include color variations, font variations, or any other method designed to allow the user to quickly identify the differences between the two product profiles being compared. Additionally, the display module 166 may sort the attributes and/or differences in attributes to provide a more user-friendly interface. For example, the attributes may be sorted according to attributes that are deemed most important by a user (or by the application program 160). Further, the user of the application program 160 may be able to control the display module 166 (e.g., through a graphical user interface) to show the differences between the product profiles in a manner desirable to them. For instance, in the case where the product profiles represent mobile phones, a user may wish to view only the differences between product profiles that are related to the media player installed on the mobile phones. Those skilled in the art will readily recognize that other display variations may be provided to allow a user to quickly determine the differences between two or more product profiles.

FIGS. 3-6 illustrate various screenshots of a graphical user interface (GUI) 200 for an exemplary application program (such as the application program 160 shown in FIG. 2) that is operative to allow users to compare differences between two different product profiles. Although, the application program shown in FIGS. 3-6 and described below is a particular computer program for emulating mobile devices, it should be appreciated that the features described herein may be applicable to other application programs as well. Initially, the description below generally describes the application program, and then proceeds to describe the comparison features more specifically.

Devices with digital screens, such as mobile phones, media players, navigation systems, cameras, and the like, are becoming increasingly popular. For example, there are literally billions of mobile phone users worldwide. Mobile phones often have unique ring tones, wallpaper, screen savers, computer programs, user interface themes, data services, video/audio playback features, and other attributes. Generally, the potential for media and applications for mobile devices is vast, and provides designers and developers with great opportunities to create new media and applications for these devices. However, there are some challenges to designing and developing applications for mobile devices. For example, one of the biggest challenges stems from the large amount of variation in device attributes. Screen resolutions, processors, memory, input mechanisms, operating systems, manufacturers, and the like are just a few examples of ways that devices can vary significantly from one to another. Additionally, new devices with new or different attributes are constantly being introduced to the market, requiring developers to design applications that will function on the new devices as well as legacy devices. In this regard, professional media companies targeting mobile devices may spend large sums of money to purchase mobile devices for the purpose of analyzing their new applications on the new mobile devices. As can be appreciated, this process can be costly and inefficient.

To remedy some of the above-noted concerns, the application program and associated GUI 200 shown in FIGS. 3-6 may provide knowledge, workflow, and functionality for mobile device authoring (e.g., development of applications for mobile devices). To achieve this functionality, the application program may provide information about the hardware, software, and media capabilities for a plurality of mobile devices, thereby allowing designers to design applications appropriate for each device. Further, the application program may allow developers to preview their applications on numerous devices using an emulation feature that includes “virtual devices.” As can be appreciated, the application program may be very useful for tasks throughout the development process, including planning, designing, testing, debugging, documenting, and presenting. The result may be a savings in time, efforts, and costs.

FIG. 3 illustrates a first screenshot of the GUI 200 of the application program described above (e.g., the application program 160 shown in FIG. 2 that is run on the computer system 100 shown in FIGS. 1 and 2). The GUI 200 includes a window 208 that includes a list of mobile phones (e.g., PHONE 1, PHONE 2, and the like). Further, the plurality of mobile phones is sorted according to one or more of their attributes. In this example, the various attributes shown in the window 208 are NAME 210, DISPLAY 212, FLASH 214 (e.g., media player version), and COLOR DEPTH 216. As can be appreciated, the phones may be searched for and organized in many useful ways including by manufacturer, screen size, content type, mobile carrier (if applicable), and other ways. Further, users may be allowed to create their own organization system for viewing and/or tracking device profiles using the GUI 200.

The GUI 200 also includes a window 202 that provides a list of phones that are currently “loaded” into the application program as test devices. In the example shown in FIG. 3, PHONE 4 and PHONE 6 are both loaded as test devices. The GUI 200 may also include a selectable list of ONLINE DEVICES 204 and LOCAL DEVICES 206. In this regard, the user may select which set of devices to be displayed in the window 208. As an example, the local devices may be the device profiles already stored on a user's computer (e.g., similar to the local product profiles 168 stored on the computer system 100 shown in FIG. 2) and the online devices may be the new device profiles available for download from a remote or online site (e.g., similar to the remote product profiles 172 stored on the remote computer system 150 shown in FIG. 2).

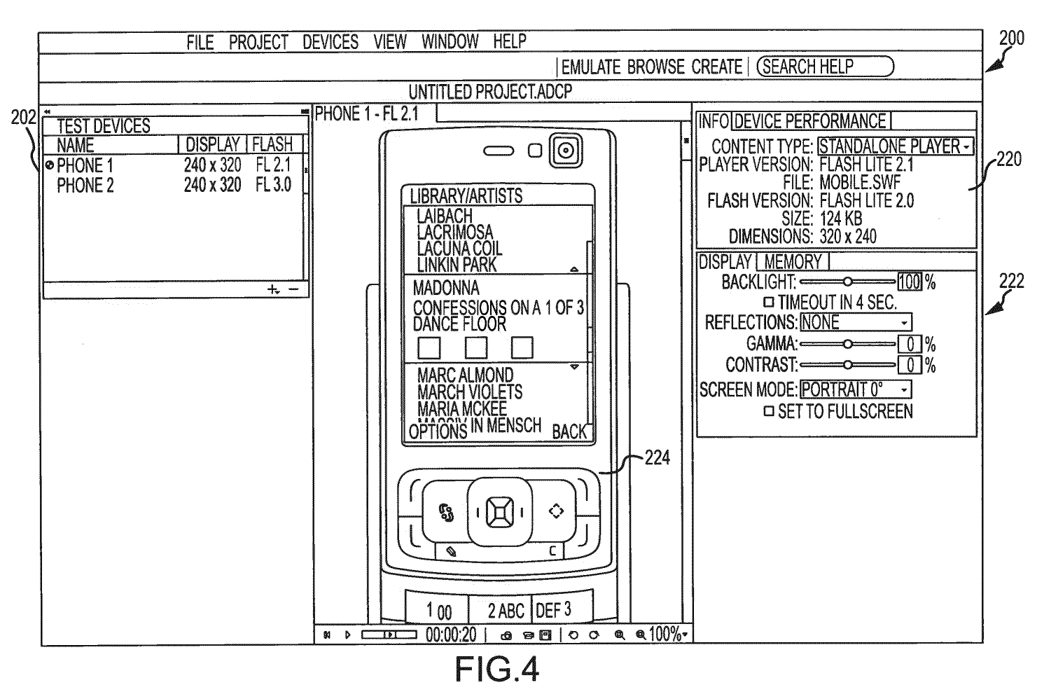

FIG. 4 illustrates the emulation features of the application program (e.g., the application program 160 shown in FIG. 2 that is run on the computer system 100 shown in FIGS. 1 and 2), wherein a user may test one or more mobile phone applications using local device profiles. In this example, a virtual representation of PHONE 1 (referenced by the numeral 224) is shown in the GUI 200. The depiction of the phone 224 on the GUI 200 may include the phone's display, input mechanisms (e.g., hard and soft buttons), as well as other features. Further, windows 220 and 222 may be provided which include information about the phone 224, such as screen information, device performance, display settings, device memory, and the like. It should be appreciated that other features and controls may be provided in the GUI 200 to emulate the operation of the phone 224.

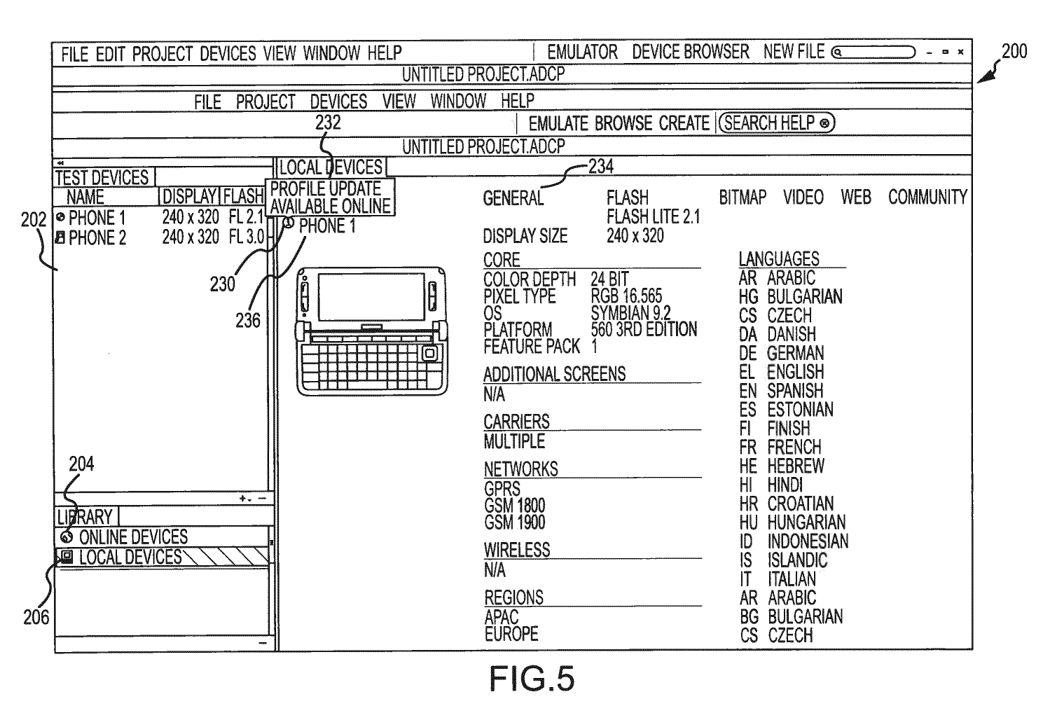

FIG. 5 illustrates a view of the GUI 200 displayed on the computer system 100 (shown in FIGS. 1 and 2) by the application program that shows the local device profile for PHONE 1 (referenced by the numeral 236 in FIG. 5). The local device profile includes various attributes 234 for the mobile phone, including display information, media player information, carrier information, network compatibility, regions, languages, and the like. It should be appreciated that other attributes may be included in the local device profile as well.

As shown in FIG. 5, an icon 230 may be provided in the display of the device profile for the phone 236. In this example, when a user positions an input device such as a mouse over the icon 230, a message 232 is displayed that notifies the user than an update for the device profile for the phone 236 is available online. In response to this message 236, a user may then choose to compare the new online device profile to the profile stored locally on the user's computer. Of course, other techniques may be used to notify a user that a new device profile is available online.

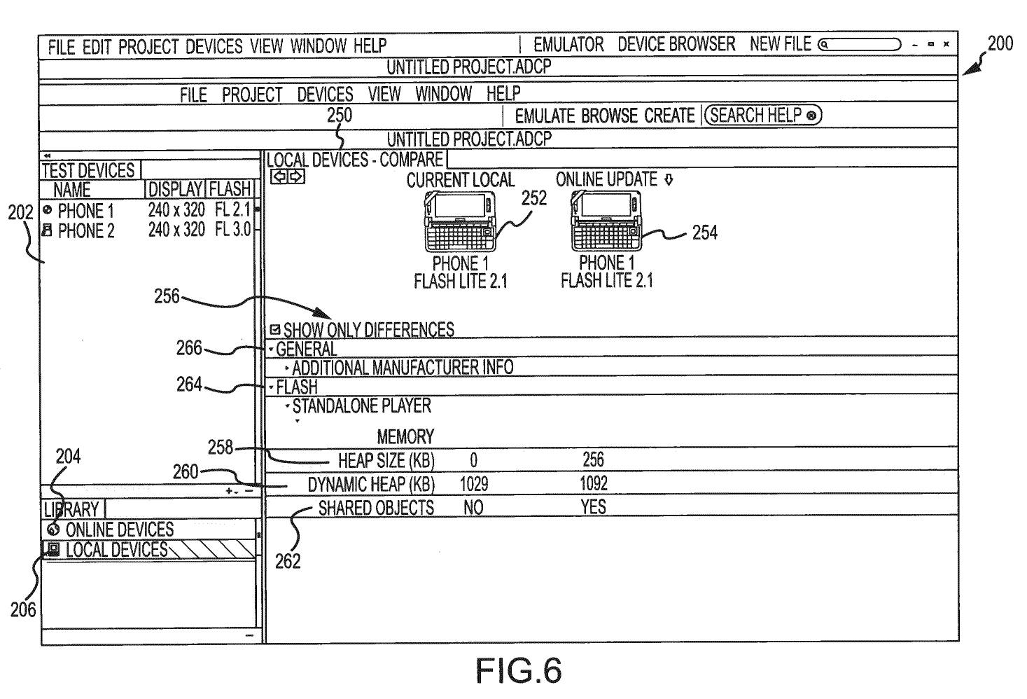

FIG. 6 illustrates the GUI 200 after a user has requested a comparison of a local device profile 252 and an online device profile 254 for PHONE 1. The downloading, comparing, and displaying of the device profiles may be performed on a computer system, such as the computer system 100 shown in FIGS. 1 and 2. As shown, a window 250 is provided that includes the local device profile 252 adjacent to or side-by-side with the online device profile 254. Additionally, a SHOW ONLY DIFFERENCES checkbox 256 is checked, such that only the attributes that are different between the local device profile 252 and the online device profile 254 arc shown on the GUI 200. Of course, other checkboxes or selection interfaces may be provided to show only similarities, highlighted similarities or differences, or the like. In this example, the list of attributes for the device profiles includes GENERAL 266, which may provide general information about the device, and may include sub-attributes such as ADDITIONAL MANUFACTURER INFO. The list of attributes may also include FLASH 264, which may provide information about the media player provided with the device. The attribute FLASH 264 may also include sub-attributes including memory information such as HEAP SIZE 258, DYNAMIC HEAP 260, and SHARED OBJECTS 262. As shown, only the attributes that are different between the two device profiles 252 and 254 are shown in this example because the SHOW ONLY DIFFERENCES checkbox 256 is checked. As can be appreciated, when the SHOW ONLY DIFFERENCES checkbox 256 is unchecked, attributes that are both the same and different between the two profiles 252 and 254 may be displayed by the GUI 200. In this case, the GUI 200 may provide some type of means for a user to quickly identify the different attributes between the profiles 252 and 254. For example, the attributes that are different may be highlighted, displayed in different color or font, or the like, such that a user may easily identify the differences between the two product profiles 252 and 254.

It should be appreciated that the ability to quickly compare the differences between an online update device profile and a local device profile may provide several advantages. For example, in the case where there is a cost associated with the online update, a user may wish to evaluate the differences between the online update device profile and the device profile already stored locally prior to committing to such a cost. If the user decides to purchase the online update, the application program may, for example, provide the user with an interface for inputting payment information (e.g., credit card or other billing information) prior to downloading the update to the user's computer. Further, in the case where a user is working with many device profiles at once, the user may decide to only download updated device profiles when particular differences in attributes are present. For example, if a user is developing applications for devices that work with a particular version of a media player, the user may wish to only download updates when the updated device profile includes changes to the media player. It will be appreciated that there may be numerous other advantages achieved by providing a user-friendly interface for allowing users to quickly identify differences between two or more device profiles.

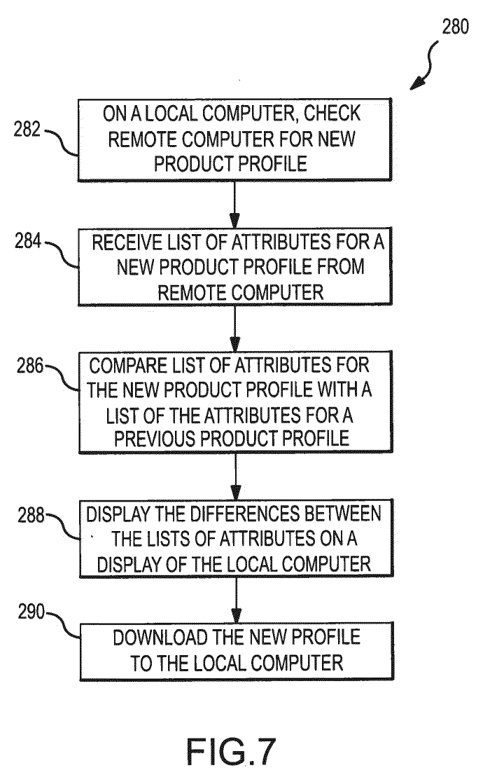

FIG. 7 illustrates a flowchart of a process 280 for providing functionality for comparing a local product (or device) profile to a product profile stored remotely, such as a profile stored in an online database. The steps of the process 280 may be performed by application programs executing on computer systems, such as application programs 160 and 170 executing on the computer systems 100 and 150 shown in FIGS. 1 and 2. The process 280 includes operating a local computer to check a remote computer coupled to the local computer for a new product profile, step 282. The process 280 also includes receiving a list of attributes for a new product profile from the remote computer, step 284. The list of attributes may include any attributes of the product represented by the product profile. For example, in the case where the product profile represents a mobile phone, the list of attributes may include manufacturer, display information, processor type, and the like.

The process 280 also includes comparing the list of attributes of the new product profile with a list of attributes for a product profile already stored locally on the local computer, step 286. For example, step 286 may include determining which attributes are different between the two product profiles. Additionally, step 286 may include sorting the attributes according to some criteria (e.g., which attributes are more important as determined by a user or the application).

The process 280 may also include displaying the differences between the lists of attributes for the local product profile and the remote product profile on a display of the local computer, step 288. As described above with reference to FIGS. 3-6, step 288 may include displaying only the differences (or highlighting the differences) in attributes between the local and remote product profiles so that a user may quickly determine whether to download the product profile stored on the remote computer. Further, the process 280 includes downloading the new profile (e.g., in response to a user request) to the local computer from the remote computer, step 290.

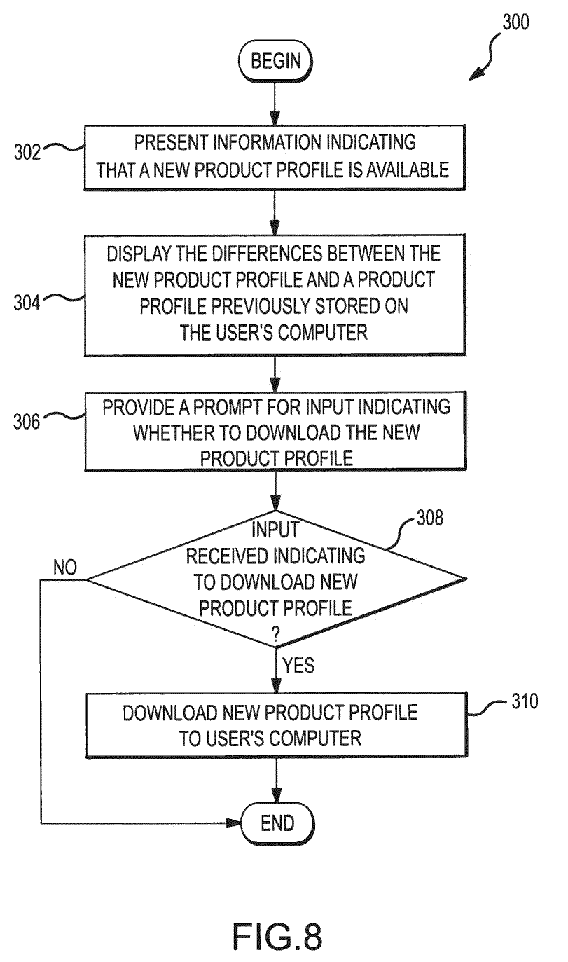

FIG. 8 illustrates a flowchart of a process 300 for providing a new product profile to a user of a local computer system, such as the computer system 100 shown in FIG. 1. The steps of the process 300 may be performed by application programs executing on computer systems, such as application programs 160 and 170 executing on the computer systems 100 and 150 shown in FIGS. 1 and 2. The process 300 includes presenting information to a user indicating that a new product profile is available, step 302. For example, as illustrated by the icon 230 shown in FIG. 5, an icon or other means may be used to notify the user of the availability of a new product profile. Similar to previously described embodiments, the process 300 also includes displaying the differences between the new product profile and a product profile previously stored locally on a user's computer, step 304.

The process 300 further includes providing a prompt for input indicating whether to download the new product profile, step 306. In making this determination, the user may rely on the visual display of the differences between the attributes of the new product profile and the product profile stored locally. Further, whether the user chooses to request download of the new product profile may be dependent upon the cost associated with downloading the new product profile, or any other concerns. If input is received indicating a request to download the new product profile, step 308, the new product profile may be downloaded from the remote computer to the user's computer through a suitable communications path, such as the Internet, step 310.

It should be appreciated that the profiles that are compared by the various embodiments described herein are not limited to any particular products. Further, the comparison functionality may be used to compare profiles representing two or more different products, two or more versions of the same product, or any combination thereof. Additionally, the profiles that are compared may be stored on a single computer, or on multiple computers as described in the description above. Those skilled in the art will readily recognize that the features described herein provide for comparing profiles of various products in numerous combinations and ways.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, a data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Generally, the elements of a computer are a processor for performing instructions and one or more memory devices for storing instructions and data. Typically, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, a digital camera, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products.

1. A computer-implemented method, comprising:
on a first computer, retrieving a first product profile that includes attributes including hardware information, software information, and communications capabilities associated with a first device, the first product profile stored locally at the first computer;
retrieving from a second computer remotely located from and communicatively coupled with the first computer a second product profile that includes attributes including hardware information, software information, and communications capabilities associated with a second device;
comparing the first product profile with the second product profile; and
displaying via a graphical user interface of the first computer a subset of the attributes based on the comparison.

2. The computer-implemented method of claim 1, wherein the subset of the attributes includes attributes that are different between the first product profile and second product profile.

3. The computer-implemented method of claim 1, wherein displaying a subset of the attributes based on the comparison includes:
highlighting attributes that are different between the first product profile and the second product profile.

4. The computer-implemented method of claim 1, wherein the first device and the second device are a same device, and wherein the second product profile represents a different, updated version of the same device represented by the first product profile.

5. The computer-implemented method of claim 1, wherein the first device is different than the second device.

6. (canceled)

7. The computer-implemented method of claim 1, further comprising:
on the first computer, receiving input requesting a download of the second product profile; and
in response to the input, downloading the second product profile from the second computer to the first computer.

8. The computer-implemented method of claim 7, further comprising:
receiving payment information via the graphical user interface of the first computer.

9. The computer-implemented method of claim 1, wherein displaying at least a subset of the attributes based on the comparison includes sorting the attributes according to a set of criteria.

10. The computer-implemented method of claim 1, wherein the first product profile and the second product profile represent mobile electronic devices.

11-21. (canceled)

22. A system supported by a computing device, comprising:
one or more hardware modules, including:
a comparison module configured to identify differences between a first product profile that describes attributes including hardware information, software information, and communications capabilities of a first device, the first product profile locally stored by the computing device and a second product profile that describes attributes including hardware information, software information, and communications capabilities of a second device, the second product profile stored remotely from the computing device; and
a display module configured to display, via a graphical user interface of the computing device, information associated with the identified differences between the first product profile and the second product profile.

23. The system of claim 22, wherein the first device and the second device are a same device and wherein the comparison module is configured to identify differences between the first product profile that describes attributes of a version of software for the same device and the second product profile that describes attributes of an update to the version of the software for the same device.

24. (canceled)

25. The system of claim 22, wherein the first device is a first mobile device and the second device is a second mobile device.

26. The system of claim 22, wherein the display module is configured to highlight information associated with the identified differences between the first product profile and the second product profile.

27. The system of claim 22, wherein the display module is configured to display information associated with attributes of the second product profile that are different than attributes of the first product profile.

28. A non-transitory computer-readable storage medium whose contents, when executed by a computing device, cause the computing device to perform a operations, comprising:
identifying differences between a first product profile that describes attributes including hardware information, software information, and communications capabilities of a first device, the first product profile locally stored by the computing device and a second product profile that describes attributes including hardware information, software information, and communications capabilities of a second device, the second product profile stored remotely from the computing device; and
displaying, via a graphical user interface of the computing device, information associated with the identified differences between the first product profile and the second product profile.

29. The computer-readable storage medium of claim 28, wherein the first device and the second device are a same device and wherein identifying differences between the first product profile and the second product profile includes identifying differences between attributes of a version of software for the same device and attributes of an update to the version of the software for the same device.

30-31. (canceled)

32. The computer-readable storage medium of claim 28, wherein displaying information associated with the identified differences between the first product profile and the second product profile includes highlighting information associated with the identified differences between the first product profile and the second product profile.

33. The computer-readable storage medium of claim 28, wherein displaying information associated with the identified differences between the first product profile and the second product profile includes displaying information associated with attributes of the second product profile that are different than attributes of the first product profile.
